(19) United States
(12) Patent Application Publication
(10) Pub. No.: US 2014/0182929 A1
(43) Pub. Date: Jul. 3, 2014

(54) CABLE MANAGEMENT APPARATUS

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventors: BIAO ZENG, Wuhan (CN); ZHI-QIANG LI, Wuhan (CN); YI SHU, Wuhan (CN); TAO ZHANG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/039,096

(22) Filed: Sep. 27, 2013

(30) Foreign Application Priority Data
Dec. 28, 2012 (CN) 2012105821706

(51) Int. Cl. H02G 3/22

(52) U.S. Cl. CPC H02G 3/22
USPC 174/650

(57) ABSTRACT

A cable management apparatus includes a plate and a cable management clip. The plate defines an opening for a plurality of cables extending therethrough. The cable management clip is connected to an edge of the opening. The cable management clip includes a blocking piece. A width of blocking piece is larger than a width of the opening. The blocking piece is attracted on the plate to restrict the plurality of cables between the plate and the cable management clip.

### BACKGROUND

1. Technical Field

The present disclosure relates to cable management apparatuses, and more particularly to a cable management apparatus used in an electronic device.

2. Description of Related Art

Many electronic devices, such as computers, include multiple input and output cables. The input and output cables may include power cables, data cables, communication lines, keyboard lines, for example. It is therefore desirable to include a cable management apparatus, such as a binding accessory, that allows the cables to be collected together and attached in a preferred position to improve the appearance of the electric device and save space in the chassis. However, conventional binding accessories are not suited for temporary use in securing cables.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric, exploded view of an embodiment of a cable management apparatus.

FIG. 2 is an assembled, isometric view of the cable management apparatus of FIG. 1.

FIG. 3 is another assembled view of cable management apparatus of FIG. 1.

FIG. 4 is another assembled view of cable management apparatus of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

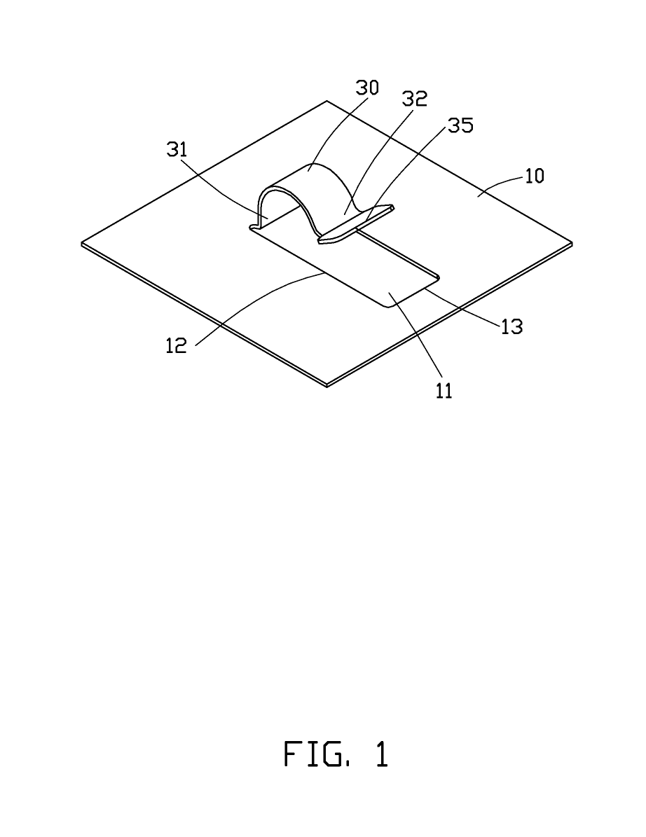

FIG. 1 shows that an embodiment of a cable management apparatus. The cable management apparatus includes a plate 10 and a cable management clip 30.

The plate 10 defines an opening 11 which is generally square in shape. The opening 11 extends through the plate 10. The plate 10 includes a pair of long edges 12 and a pair of short edges 13 surrounding the opening 11. The opening 11 can receive cables. The plate 10 is made of magnetic material, such as iron or steel, for example.

The cable management clip 30 is generally a semi-circle flexible piece. The cable management clip 30 includes a first end 31 and a second end 32. The first end 31 is connected to a short edge 13 of the plate 10. A blocking piece 35 is connected to the second end 32 of the cable management clip 30. The blocking piece 35 is made of magnet. Therefore, the blocking piece 35 can be attracted on the plate 10 by a magnetic force formed between the blocking piece and the plate. A width of the blocking piece 35 is larger than a length of the short edge 13.

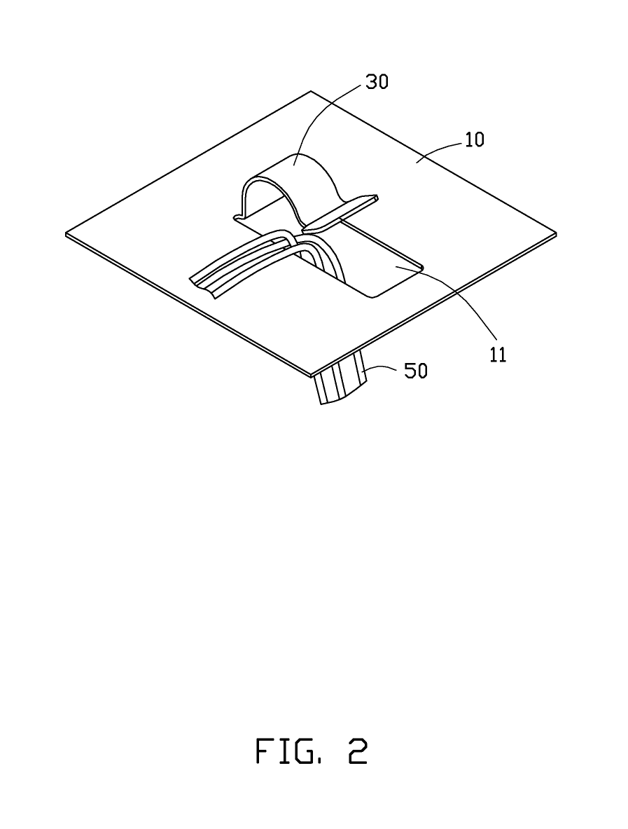

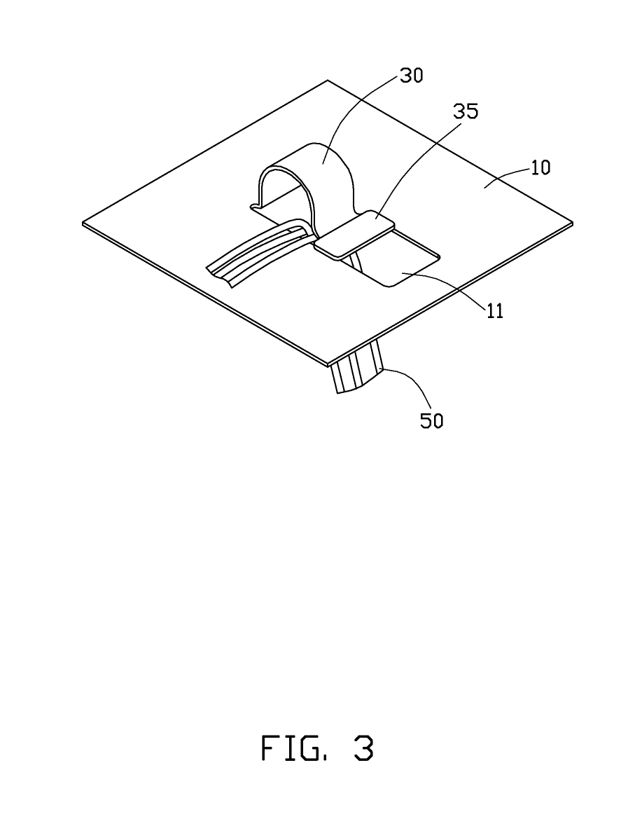

FIGS. 1 to 3 show that in use, a plurality of cables 50 extends through the opening 11 in a upright direction from a bottom portion of the plate 10 to a side of the cable management clip 30 or to two sides of the cable management clip 30. Then, the cable management clip 30 is elastically bent to have the blocking piece 35 attracted on the plate 10. Thereby, the plurality of cables 50 is managed.

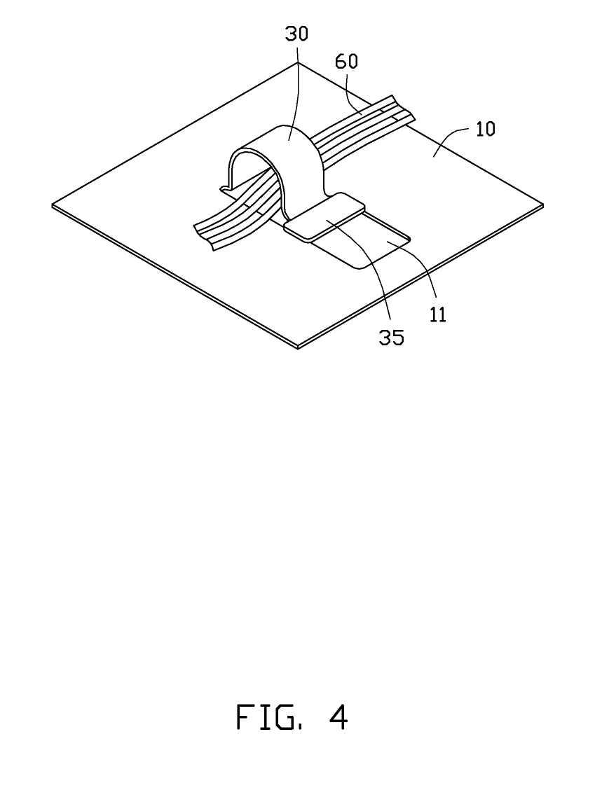

FIG. 4 shows that the cable management apparatus also can mange a plurality of cables 60 in a horizontal direction. The plurality of cables 60 is placed on the plate 10 and located below the cable management clip 30. The cable management clip 30 is elastically bent to have the blocking piece 35 attracted on the plate 10. Thereby, the plurality of cables 60 is managed.

In the above embodiment, the cable management apparatus also can manage cables in upright direction and in horizontal direction simultaneously and temporary.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A cable management apparatus, comprising:
a plate defining an opening configure for multiple cables extending therethrough; and
a cable management clip connected to an edge of the opening, the cable management clip comprising a blocking piece, a width of blocking piece being larger than a width of the opening, the blocking piece being attracted on the plate and configured to restrict the cables between the plate and the cable management clip.

2. The cable management apparatus of claim 1, wherein the plate comprises a pair of long edges and a pair of short edges, the long edges and the short edges cooperatively surrounds the opening, and the cable management clip comprises a first end, and the first end is connected to one of the pair of short edges.

3. The cable management apparatus of claim 2, wherein the cable management clip comprises a second end on which the blocking piece is connected, and the width of the blocking piece is larger than a length of the short edge.

4. The cable management apparatus of claim 1, wherein the plate is made of magnetic material, the blocking piece is made of magnet, and the blocking piece is magnetically attracted on the plate by a magnetic force.

5. The cable management apparatus of claim 1, wherein the cable management clip is a semi-circle and flexible piece.

6. The cable management apparatus of claim 1, wherein the cables extend through the opening in an upright direction from a bottom portion of the plate to a side of the cable management clip or to two sides of the cable management clip.

7. The cable management apparatus of claim 1, wherein the cables are placed on the plate and located below the cable management clip.

8. A cable management apparatus, comprising:
a plate made of magnetic material;
a cable management clip comprising a first end and a second end, the first end being connected to the plate; and
a blocking piece connected to the second end, the blocking piece being made of magnet, the blocking piece being magnetically attracted on the plate.

9. The cable management apparatus of claim 8, wherein the plate defines an opening, the first end is connected to an edge of the opening and configured for multiple cables extending therethrough, a width of blocking piece being larger than a width of the opening, and the cables are restricted between the plate and the cable management clip.

10. The cable management apparatus of claim 9, wherein the plate comprises a pair of long edges and a pair of short edges, the long edges and the short edges cooperatively surrounds the opening, and the cable management clip comprises a first end, the first end is connected to one of the pair of short edges, and the width of the blocking piece is larger than a length of the short edge.

11. The cable management apparatus of claim 9, wherein the cables extend through the opening in an upright direction from a bottom portion of the plate to a side of the cable management clip or to two sides of the cable management clip.

12. The cable management apparatus of claim 9, wherein the cables are placed on the plate and located below the cable management clip.

13. The cable management apparatus of claim 8, wherein the cable management clip is a semi-circle and flexible piece.
